(19) United States
(12) Patent Application Publication
(10) Pub. No.: US 2022/0276973 A1
(43) Pub. Date: Sep. 1, 2022

(54) DATA TRANSMISSION EVENT USED FOR INTERCONNECTED DIES

(71) Applicant: 58th Research Institute of China Electronics Technology Group Corporation, Wuxi, Jiangsu (CN)

(72) Inventors: Jinghe Wei, Wuxi, Jiangsu (CN); Letian Huang, Wuxi, Jiangsu (CN); Zhiqiang Xiao, Wuxi, Jiangsu (CN); Mingang Feng, Wuxi, Jiangsu (CN); De Liu, Wuxi, Jiangsu (CN); Qing Tian, Wuxi, Jiangsu (CN)

(21) Appl. No.: 17/626,826

(22) PCT Filed: Dec. 16, 2021
(86) PCT No.: PCT/CN2021/138705

§ 371 Date: Jan. 13, 2022

(30) Foreign Application Priority Data
Feb. 5, 2021 (CN) 20211016052636

(51) Int. Cl. G06F 13/24; G06F 13/42; G06F 13/362

(52) U.S. Cl. CPC G06F 13/24; G06F 13/4221; G06F 13/362

(57) ABSTRACT

The invention relates to a data transmission method, in particular to a data transmission event used for interconnected dies, comprising read events, write events and interrupt events; the read event comprises read request events and read response events; the write event comprises write data events and write response events; the write data event and the read request event are both sent by the master device and received by the slave device; the writing response event and the read response event are both sent by the slave device and received by the master device. The data transmission event for interconnected dies provided by the invention matches the basic event types with the channels in many expansion interfaces, and each transmission channel only supports the input or output of the specified basic type of event data packets, which ensures the efficiency and reliability of communication; compared with the multiple channels of conventional memory-mapped buses or master-slave buses, this method of encoding basic events into data packets for transmission only requires input and output channels, which reduces interconnection requirements and simplifies channel control logic.

### BACKGROUND OF THE INVENTION

### 1. Field of the Invention

The invention relates to a data transmission method, in particular to data transmission event used for interconnected dies.

### 2. Description of Related Art

In a monolithic application specific integrated circuit, all components are designed and manufactured on the same silicon chip using the same process. As the process dimension shrinks, the cost and development cycle of developing such integrated circuits have become extremely high. Under this circumstance, multiple dies integration is an inevitable alternative. That is, connect and assemble multiple chip components with different functions that have been verified and not packaged, and package them as a whole chip in the same shell to form a NoP (Network on Package). These dies can use different processes and come from different manufacturers, thus greatly shortening and reducing the development cycle and difficulty. The difficulty of multi-die integration lies in how to efficiently interconnect each die and ensure that high micro-system performance is achieved under power consumption constraints. The existing communication protocols for multi-die integration are either dedicated protocols with poor versatility; or the technical system is too complex and difficult to use. On the stage where the multi-die interconnection bus protocol is immature, how to define a multi-die interconnection bus protocol that meets China's current integrated circuit development needs based on China's actual conditions and current technical level is the key problem to interrupting through the new generation of integrated micro-system.

To this end, it is necessary to define support for multiple dies for high-speed interconnection, support for conversion and intercommunication between standard communication interfaces (such as PCIE, RapidIO, etc.), and support for multiple interconnection chips for cascading and expansion to further form a larger multi-die interconnection bus protocol for interconnection network on package. Design and implement interconnected dies on the basis of the bus protocol, which lays the foundation for subsequent micro-system integration.

Because that interconnected dies possesses many types of expansion interfaces, how to ensure the efficiency and reliability of data transmission is an urgent problem to be solved.

### SUMMARY OF THE INVENTION

To solve the above problems, the invention provides a data transmission event used for interconnected dies. Aiming at the various types of expansion interfaces in interconnected dies, the data transmission event type is defined to support data interaction between various devices. As for the different channels of each interface, the supported event types vary. Therefore, while defining the basic event types, define the basic event types that can be supported for the different channels of each interface in order to ensure the efficiency and reliability of data transmission.

The specific technical solution is:

Data transmission event used for interconnected dies, comprising read event, write event and interrupt event; the read event comprises read request event and read response event; the write event comprises write data event and write response event; the write data event and the read request event are both sent by the master device and received by the slave device; the write response event and read response event are both sent by the slave device and received by the master device.

Furthermore, the output channel of the interface converter of the master device is used for output of event data packets of write data events and read request events; the input channel of the master device interface converter is used for writing the response event and reading the event data packet input of the response event; the input channel of the interface converter of the slave device is used for the event data packet input of the write data event and the read request event; the output channel of the slave device interface converter is used to output the event data packet of the write response event and read the response event.

Among them, the master device interface converter and the slave device interface converter both include a data interface and an interrupt interface, and the data interface is used for the transmission of read event and write event, and the interrupt interface is used for the transmission of interrupt events.

Preferably, the interrupt event is transmitted through the network in the form of a data packet.

Furthermore, the interrupt interface of the master device is used to unpack the interrupt event data packet from the network into a corresponding interrupt pulse and send it to the master device; the interrupt interface of the slave device is used to collect the pulse interrupt information from the slave device and then encode it into an interrupt event data packet and then send it to the network.

Preferably, the input channel and output channel of the peer device are set with multiple virtual channels after the packing and unpacking module, and the multiple virtual channels are respectively used for the transmission of write data event and read request event, as well as write response event and read response event.

Preferably, the data packets of the read event, write event and the interrupt event all include a head flit, one or more body flits, and a tail flit; the body flit includes event type codes and all event information codes, and the event information codes include information ID and main information.

Furthermore, the body flit contains the information code of a long event or several short events; the information code of a long event is the code whose length multiplied by two is greater than the length of the body flit data; the information code of a short event is the code whose length multiplied by two is shorter than the length of the body flit data.

Preferably, the number of the body flits is determined by the number of event information and the flit width, which is the bit width of the physical channel DATA signal; the number of flits after data packet packaging for a basic event is:

$${N}_{bodymicrochip} = {N}_{longinformationcodeofevent} + \frac{{N}_{shortinformationcodeofevent}}{{W}_{DATA} / {W}_{shortinformationcodeofevent}}$$

in the formula, N_{body microchip} is the number of the body flit in the basic event packet; N_{long information code of event} is the number of long information code in the basic event; N_{short information code of event} is the number of short information code in the basic event; W_{DATA} is the width of flit, which is the bit width of the physical channel DATA signal; W_{short information code of event} is the length of the short information code in the basic event.

Furthermore, the write data event includes: data first address, address change mode, data length, write event ID and data; the write response event includes: write event ID and write event status; the read request event includes: data first address, address change mode, data length, and read event ID; the read response event includes: read event ID and data; the interrupt event includes: slave code, master code, and interrupt type code.

Compared with the prior art, the invention possesses the following advantageous effects:

The data transmission event for interconnected dies provided by the invention matches the basic event types with the channels in many expansion interfaces, and each transmission channel only supports the input or output of the specified basic type of event data packets, which ensures the efficiency and reliability of communication; compared with the multiple channels of conventional memory-mapped buses or master-slave buses, this method of encoding basic events into data packets for transmission only requires input and output channels, which reduces interconnection requirements and simplifies channel control logic.

### ILLUSTRATION

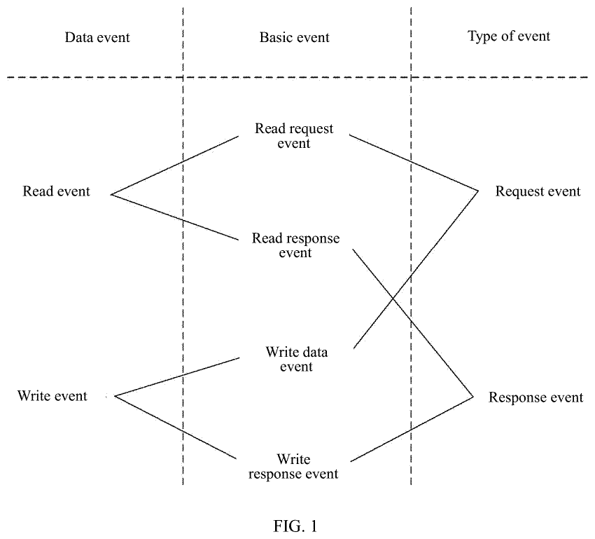

FIG. 1 is the event division and types of event;

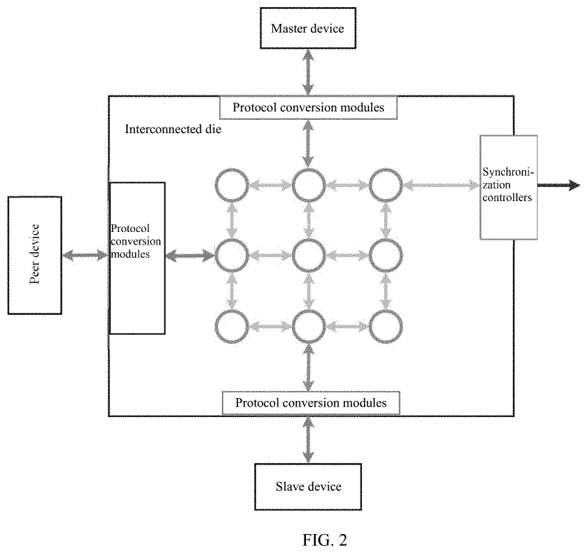

FIG. 2 is the expansion interface of the interconnected dies;

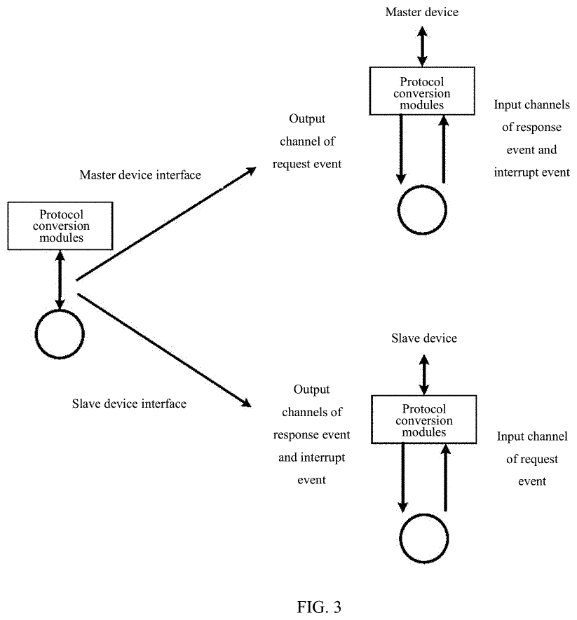

FIG. 3 are the matches of basic data event type with different channels under the master and slave interfaces;

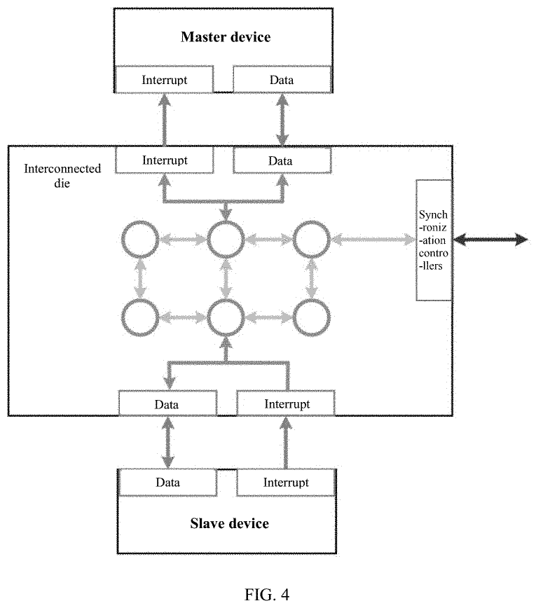

FIG. 4 is the interface of master-slave device;

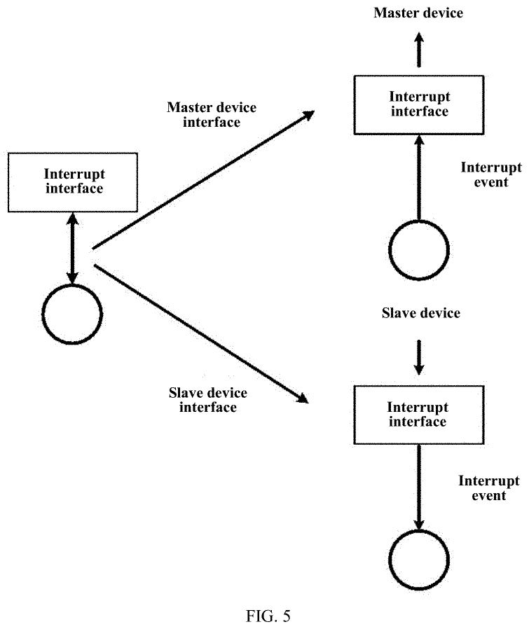

FIG. 5 is the match of interrupt event under the master and slave interfaces;

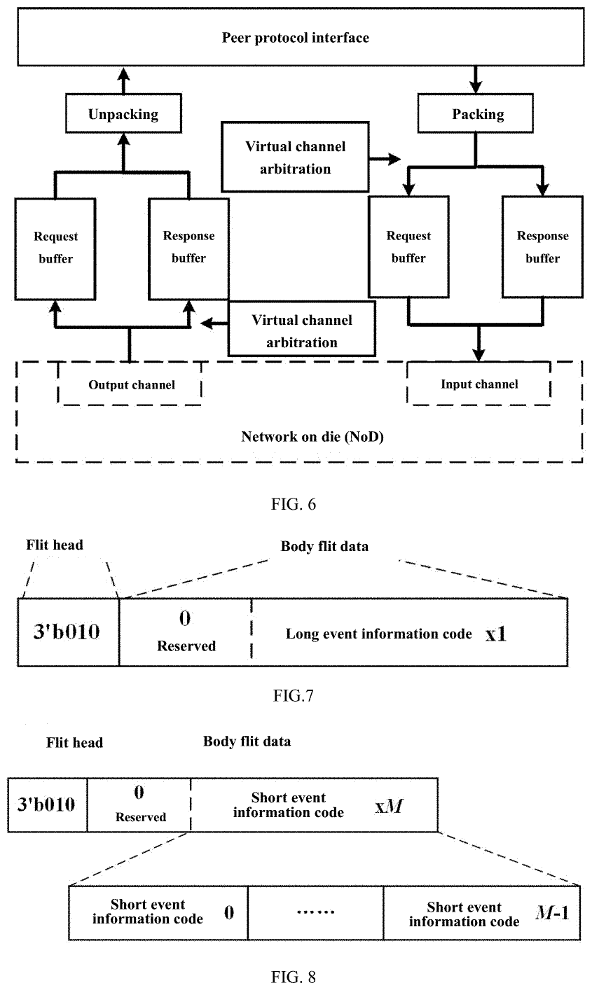

FIG. 6 is the conversion method of peer device interface;

FIG. 7 is a body flit containing a long event information code;

FIG. 8 is a body flit containing several short event information codes;

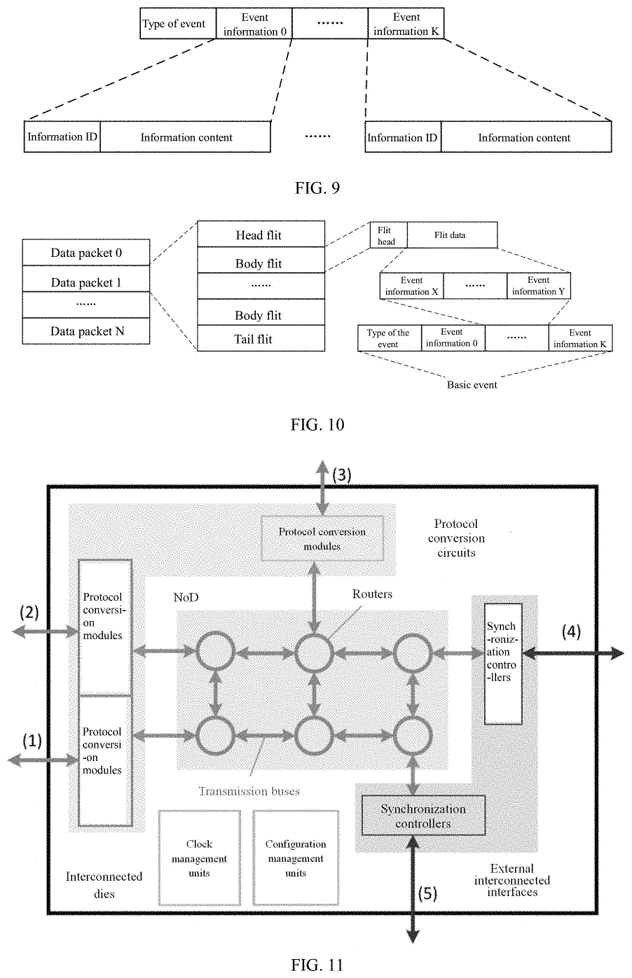

FIG. 9 is the information code;

FIG. 10 is a hierarchical representation of a complete basic event code in the data packet;

FIG. 11 is the structural diagram of the interconnected dies.

### SPECIFIC IMPLEMENTATION PLAN

The invention is further described with reference to the drawings.

In order to complete the definition of the interconnection bus protocol, it is first necessary to complete the definition of the basic signal of the protocol, and define the basic signal format of the interconnection bus, such as signal direction, signal bit width, and timing relationship between signals. Since the protocol is implemented based on the network-on-chip, it is also necessary to define the data packet format as well as the event type division and transmission method based on the data packet.

For the various types of expansion interfaces of interconnected dies, data transmission event types need to be defined to support data interaction between various devices. For different channels of each interface, the supported event types vary. Therefore, while defining the basic event types, it is also necessary to define the basic event types that can be supported by the different channels of each interface, so that the efficiency and reliability of data transmission can be guaranteed. Because the core of the interconnected die is NoD (Network on Die, a die that includes a high-speed network-on-chip and an expansion bus), which is based on network-on-chip. The network-on-chip transfers data between routers in the form of data packets, so while defining the basic event types, it is also necessary to specify the data packet format corresponding to each basic event type.

As is shown in FIG. 2 and FIG. 11, the interconnected die includes a protocol conversion circuit, and the protocol conversion circuit further includes multiple protocol conversion modules, which are used for providing multiple standard mainstream protocol interfaces for external connection; external interconnected interface, and the external interconnected interface further includes a pair of synchronization controllers, used for communicating with other interconnected dies; network on die, the network on die further includes transmission bus and a router. The synchronization controller and the protocol conversion modules are respectively connected to the boundary nodes of the network on die to transmit data packets from the interface or other interconnected dies.

The functional die is connected to the protocol conversion module through the standard protocol bus.

The interconnected dies are connected by the external interconnected interface.

The interconnected die mainly comprises three parts: network on die (Network on Die, NoD), the protocol conversion circuit and the external interconnected interface. NoD is used for data routing and high-speed transmission. Protocol conversion circuit provides a variety of standard mainstream protocol interfaces for external connection. The protocol conversion circuit includes multiple protocol conversion modules that convert the NoD protocol to the mainstream protocol for connecting with other functional dies. The external interconnected interface is mainly composed of a pair of synchronization controllers. The external interconnected interface is controlled by the synchronization controller to realize the data transmission of different clock domains inside and outside the die. Each conversion module of the external interconnected interface and the protocol conversion circuit is connected to a boundary node in the NoD, thereby forming a data transmission path.

Data transmission event used for interconnected dies, comprising read event, write event and interrupt event; the read event comprises read request event and read response event; the write event comprises write data event and write response event; the write data event and the read request event are both sent by the master device and received by the slave device; the write response event and read response event are both sent by the slave device and received by the master device.

The output channel of the interface converter of the master device is used for output of event data packets of write data events and read request events; the input channel of the master device interface converter is used for writing the response event and reading the event data packet input of the response event; the input channel of the interface converter of the slave device is used for the event data packet input of the write data event and the read request event; the output channel of the slave device interface converter is used to output the event data packet of the write response event and read the response event.

Among them, the master device interface converter and the slave device interface converter both include a data interface and an interrupt interface, and the data interface is used for the transmission of read event and write event, and the interrupt interface is used for the transmission of interrupt events.

The interrupt event is transmitted through the network in the form of a data packet.

The interrupt interface of the master device is used to unpack the interrupt event data packet from the network into a corresponding interrupt pulse and send it to the master device; the interrupt interface of the slave device is used to collect the pulse interrupt information from the slave device and then encode it into an interrupt event data packet and then send it to the network.

The input channel and output channel of the peer device are set with multiple virtual channels after the packing and unpacking module, and the multiple virtual channels are respectively used for the transmission of write data event and read request event, as well as write response event and read response event.

The data packets of the read event, write event and the interrupt event all include a head flit, one or more body flits, and a tail flit; the body flit includes event type codes and all event information codes, and the event information codes include information ID and main information.

The body flit contains the information code of a long event or several short events; the information code of a long event is the code whose length multiplied by two is greater than the length of the body flit data; the information code of a short event is the code whose length multiplied by two is shorter than the length of the body flit data.

The number of the body flits is determined by the number of event information and the flit width, which is the bit width of the physical channel DATA signal; the number of flits after data packet packaging for a basic event is:

$${N}_{bodymicrochip} = {N}_{longinformationcodeofevent} + \frac{{N}_{shortinformationcodeofevent}}{{W}_{DATA} / {W}_{shortinformationcodeofevent}}$$

In the formula, N_{body microchip} is the number of the body flit in the basic event packet; N_{long information code of event} is the number of long information code in the basic event; N_{short information code of event} is the number of short information code in the basic event; W_{DATA} is the width of flit, which is the bit width of the physical channel DATA signal; W_{short information code of event} is the length of the short information code in the basic event.

The write data event includes: data first address, address change mode, data length, write event ID and data; the write response event includes: write event ID and write event status; the read request event includes: data first address, address change mode, data length, and read event ID; the read response event includes: read event ID and data; the interrupt event includes: slave code, master code, and interrupt type code.

Specifically, the data transmission event used for interconnected dies defines two data events: read event and write event. The read event further comprises two basic events: read request event and read response event; the write event also further comprises two events: write data event and write response event. All four kinds of basic events can be divided into two categories according to the event types: request event and response event. Both write data event and read request event belong to the request event category, which is characterized by being sent by the master device and received by the slave device; the write response event and read response event both belong to the response event category, which is characterized by being sent by the slave device and received by the master device. The event division and types are shown in FIG. 1.

In addition to the data event, an interrupt event is also required. This is because NoD, as an interconnection chip, has the vast majority of its wiring space occupied by the interconnection network. The continued use of conventional point-to-point interrupts will lead to a sharp increase in the difficulty of wiring. Therefore, the interrupt event is used to transmit the interrupt through the network in the form of a data packet, and no additional wiring resources are consumed.

As shown in FIG. 2, there are two types of interfaces in the interconnected die expansion interface: master-slave and peer-to-peer. The master-slave interface means that the two parties in communication are divided into one master device and one slave device. The communication must be initiated by the master device and received by the slave device, and the interrupt must be initiated by the slave device and received by the master device. Typical master-slave interfaces include but are not limited to DDR, PCIe, USB, etc. Peer-to-peer interface means that there is no master and slave restriction or distinction between the two communication parties, either party can initiate the communication. Typical peer-to-peer interfaces include but are not limited to UART, RapidIO, Ethernet, etc. Through the definition and implementation of these two interface types, the interconnected die can support most of the existing standard protocols.

For the master device interface converter, its output channel is only for requesting the output of event data packets, and its input channel is only for responding to the input of event data packets; for the slave interface converter, its input channel is only for requesting the input of event data packets, and its output channel is only for responding to the output of event data packets, as is shown in FIG. 3.

In fact, the master-slave interface includes two interfaces: data interface and interrupt interface. The data interface is responsible for the transmission of read and write event, and the interrupt interface is responsible for the transmission of interrupt event, as is shown in FIG. 4.

Therefore, for the master device interrupt interface converter, its interrupt interface is responsible for unpacking the interrupt event data packet from the network into the corresponding interrupt pulse and sending it to the master device; for the slave interrupt interface converter, its interrupt interface collects the pulse interrupt information from the slave device and encodes it into an interrupt event data packet, and then sends it to the network, as is shown in FIG. 5.

The peer-to-peer device interface does not possess master-slave features, so both input and output channels can pass request event data packets and response event data packets. But this will bring out the problem of protocol-level deadlock (the network-on-chip of grid topological structure may form a ring deadlock that crosses multiple routers; because the data packets in the network form a ring in the forward direction, all the data packets are waiting for the free buffer unit in the front-level router, but the buffer unit in the front-level router needs the data packet to be sent out before it can be released; a dependency loop formed by this will cause a deadlock in the network-on-chip). Therefore, it is necessary to set up multiple virtual channels to distinguish the request from the response after the input and output channels are packed and unpacked, as is shown in FIG. 6. If the peer device is used as a virtual master device or a virtual slave device and needs to perform interrupt transmission, the interrupt event data packet is still received and sent through the input and output channels shown in FIG. 6. But the sending of the interrupt original information and the analysis of interrupted information are realized by software.

Because the core of the interconnected die is NoD, which is based on the network-on-chip, and the network-on-chip transmits data between routers in the form of data packets, it is also necessary to specify the data packet format corresponding to each basic event type while defining the basic event types.

The basic event is composed of the type code of the basic event and the event information code. The event code, as the payload of the data packet, is carried by one or more body flits. After the event information is encoded, the length of the information code varies due to different information types, which can be divided into two types of information code: long event information code, whose length multiplied by two is greater than the length of the body flit data, meaning one body flit can only contain one information code of the long event; short event information code, whose length multiplied by two is shorter than the length of the body flit data, meaning one body flit contains multiple information codes of the short event. FIG. 7 shows a long event information code placed in one flit, and FIG. 8 shows multiple short event information codes placed in one flit. The number of body flits required for a basic event is determined by the number of event information and the width of the flit, which is the bit width of the physical channel DATA signal. The number of body flits for a basic event after data packet packing is:

$${N}_{bodymicrochip} = {N}_{longinformationcodeofevent} + \frac{{N}_{shortinformationcodeofevent}}{{W}_{DATA} / {W}_{shortinformationcodeofevent}}$$

In the formula, N_{body microchip} is the number of the body flit in the basic event packet; N_{long information code of event} is the number of long information code in the basic event; N_{short information code of event} is the number of short information code in the basic event; W_{DATA} is the width of flit, which is the bit width of the physical channel DATA signal; W_{short information code of event} is the length of the short information code in the basic event.

An event code requires to be composed of multiple event information. The event code needs multiple event information to include all the contents of the current event. The integrity of the event information needs to be guaranteed by the event information number, which is the information ID. As is shown in FIG. 9, one piece of event information is composed of information ID and main information.

Therefore, the expression hierarchy of basic events in the data packet is: the data packet consists of a head flit, one or more body flits, and a tail flit. The body flit contains the codes of event types and all the event information codes. Meanwhile, a body flit contains one long event information code or multiple short event information codes, and all the information codes in all body flits together form a complete basic event, as is shown in FIG. 10.

The basic event type encoding should include the following information:

The write data event is the master device writing data to the slave device. In the write data event, the basic event information that should be included: data first address, address conversion mode (address increment, address boundary loop, etc.), data length, write event ID, data.

The write response event is the slave device sending a response packet to the master device after receiving the write data event. The basic event information that should be included: write event ID, write event status (success, data loss, request retransmission).

The read request data is the master device sending read request to the slave device. The basic event information that should be included: data first address, address change mode, data length, read event ID.

The read response event is the slave device returning the read data to the master device. The basic event information that should be included: read event ID, data.

The interrupt event is the slave interface sending the interrupt data packets to the destination master device after receiving the interrupt of the slave device. The basic event information that should be included: slave code, master code and interrupt code.

The advantages of the data transmission event used for interconnected dies:

1. This method matches the basic event type with the channels in many expansion interfaces, and each transmission channel only supports the input or output of the specified basic event type data packet, which ensures the efficiency and reliability of communication.

2. Conventional memory mapped bus or master-slave bus is usually provided with multiple channels. For example, the AXI4 bus has a total of read address channel, read data channel, write address channel, write data channel and write response channel. The integrity of its transmission is controlled by the interdependence between channels. This multi-channel structure will bring huge module and interconnection line density and complex inter-channel dependency and control. However, the basic event data transmission method only requires two channels of input and output. The data in the channel is transmitted in the format of data packets. Compared with the AXI4 bus, this method can greatly reduce the interconnection requirements and simplify the complexity of the channel control logic.

The technical principle of the invention is described above in reference to the specific embodiments. These descriptions are only for explaining the principle of the invention, and cannot be construed as limiting the scope of protection of the invention in any way. Based on the explanation herein, those skilled in the art can think of other specific embodiments of the invention without creative work, and these embodiments shall all fall within the protection scope of the claims of the invention.

1. Data transmission event used for interconnected dies, comprising read events, write events and interrupt events; the read event comprises read request events and read response events; the write event comprises write data events and write response events; the write data event and the read request event are both sent by the master device and received by the slave device; the write response event and read response event are both sent by the slave device and received by the master device.

2. The data transmission event used for interconnected dies according to claim 1, wherein the output channel of the interface converter of the master device is used for output of event data packets of write data events and read request events; the input channel of the interface converter of the master device is used for writing the response event and reading the event data packet input of the response event; the input channel of the slave device interface converter is used for the event data packet input of the write data event and the read request event; the output channel of the slave device interface converter is used to output the event data packet of the write response event and read the response event.

3. The data transmission event used for interconnected dies according to claim 2, wherein the master device interface converter and the slave device interface converter both include a data interface and an interrupt interface; the data interface is used for the transmission of read event and write event, and the interrupt interface is used for the transmission of interrupt events.

4. The data transmission event used for interconnected dies according to claim 3, wherein the interrupt event is transmitted through the network in the form of a data packet.

5. The data transmission event used for interconnected dies according to claim 4, wherein the interrupt interface of the master device is used to unpack the interrupt event data packet from the network into a corresponding interrupt pulse and send it to the master device; the interrupt interface of the slave device is used to collect the pulse interrupt information from the slave device and then encode it into an interrupt event data packet and then send it to the network.

6. The data transmission event used for interconnected dies according to claim 1, wherein the input channel and output channel of the peer device are set with multiple virtual channels after the packing and unpacking module, and the multiple virtual channels are respectively used for the transmission of write data event and read request event, as well as write response event and read response event.

7. The data transmission event used for interconnected dies according to any of the claim 1 to claim 6, wherein the data packets of the read event, the write event and the interrupt event all include a head flit, one or more body flits, and a tail flit; the body flit includes event type codes and all event information codes, and the event information codes include information ID and main information.

8. The data transmission event used for interconnected dies according to claim 7, wherein the body flit contains one long event information code or several short event information codes; the information code of a long event is the code whose length multiplied by two is greater than the length of the body flit data; the information code of a short event is the code whose length multiplied by two is shorter than the length of the body flit data.

9. The data transmission event used for interconnected dies according to claim 8, wherein the number of the body flits is determined by the number of event information and the flit width, which is the bit width of the physical channel DATA signal; the number of flits after data packet packaging for a basic event is:
$${N}_{bodymicrochip} = {N}_{longinformationcodeofevent} + \frac{{N}_{shortinformationcodeofevent}}{{W}_{DATA} / {W}_{shortinformationcodeofevent}}$$
in the formula, N_{body microchip} is the number of the body flit in the basic event packet; N_{long information code of event} is the number of long information code in the basic event; N_{short information code of event} is the number of short information code in the basic event; W_{DATA} is the width of flit, which is the bit width of the physical channel DATA signal; W_{short information code of event} is the length of the short information code in the basic event.

10. The data transmission event used for interconnected dies according to claim 7, wherein the write data event includes: data first address, address change mode, data length, write event ID and data; the write response event includes: write event ID and write event status; the read request event includes: data first address, address change mode, data length, and read event ID; the read response event includes: read event ID and data; the interrupt event includes: slave code, master code, and interrupt type code.
